(19) United States
(12) Patent Application Publication
(10) Pub. No.: US 2026/0319199 A1
(43) Pub. Date: Oct. 15, 2026

(54) PLUGGABLE ELECTRONIC MODULE WITH A LOW FRICTION PORTION

(71) Applicant: MELLANOX TECHNOLOGIES, LTD., Yokneam (IL)

(72) Inventors: Sagi Porat, Haifa (IL); Jamal Mousa, Haifa (IL); Nuphar Bianco-Stein, Haifa (IL); Faheem Shihada, Haifa (IL); Nimer Hazin, Ba'ne (IL); Andrey Ger, Shlomi (IL)

(21) Appl. No.: 19/268,496

(22) Filed: Jul. 14, 2025

Related U.S. Application Data
(60) Provisional application No. 63/786,564, filed on Apr. 10, 2025.

(51) Int. Cl. G02B 6/42

(52) U.S. Cl. CPC G02B 6/4261; G02B 6/4262; G02B 6/4269

(57) ABSTRACT

Examples of a pluggable electronic module are disclosed. In an example, a pluggable electronic module includes a housing that includes a rigid portion and a low friction portion covering at least a portion of the rigid portion. In an example, the low friction portion of the housing enables smooth insertion of the pluggable electronic module into a cage. In an example, the rigid portion of the housing is formed of a first material and the low friction portion of the housing is formed of a second material. In an example, the rigid portion of the housing is formed of a first material and the low friction portion of the housing is formed of a second material, wherein the second material has a reduced coefficient of friction relative to the first material, which enables smooth insertion of the pluggable electronic module into a cage.

### CROSS-REFERENCE TO RELATED APPLICATION

This application claims priority to provisional U.S. patent application Ser. No. 63/786,564, filed Apr. 10, 2025, which is incorporated by reference herein.

### FIELD

The present disclosure is generally directed to networking cable assemblies and relates more particularly to pluggable electronic modules, such as optical transceivers.

### BACKGROUND

Datacenters are the storage and data processing hubs of the Internet. Cable assemblies are used to interconnect network devices and/or network switches within a datacenter to enable high-speed communication between the network switches.

### GENERAL DESCRIPTION

Examples of a pluggable electronic module are disclosed. In an example, a pluggable electronic module includes a housing that includes a rigid portion and a low friction portion covering at least a portion of the rigid portion.

In an example, the low friction portion of the housing enables smooth insertion of the pluggable electronic module into a cage.

In an example, the rigid portion of the housing is formed of a first material and the low friction portion of the housing is formed of a second material.

In an example, the rigid portion of the housing is formed of a first material and the low friction portion of the housing is formed of a second material, wherein the second material has a reduced coefficient of friction relative to the first material, which enables smooth insertion of the pluggable electronic module into a cage.

In an example, the rigid portion of the housing and the low friction portion of the housing are at a leading edge of a back end of the pluggable electronic module.

In an example, the rigid portion of the housing is part of an integrated heat sink and the low friction portion of the housing is formed over a portion of the integrated heat sink.

In an example, the rigid portion of the housing is formed of a first material and the low friction portion of the housing is formed of a second material, wherein the first material is metal and the second material is a low friction sticker.

In an example, the rigid portion of the housing is formed of a first material and the low friction portion of the housing is formed of a second material, wherein the first material is metal and the second material is a low friction sticker that includes ultra-high-molecular-weight (UHMW) polyethylene.

In an example, the low friction portion of the housing is overmolded over the rigid portion of the housing.

In an example, the rigid portion of the housing is formed of a first material and the low friction portion of the housing is formed of a second material, wherein the first material is metal and the second material is a molded material.

In an example, the rigid portion of the housing is formed of a first material and the low friction portion of the housing is formed of a second material, wherein the first material is metal and the second material is a molded nylon.

In an example, the low friction portion of the housing is coated over the rigid portion of the housing.

In an example, the rigid portion of the housing is formed of a first material and the low friction portion of the housing is formed of a second material, wherein the first material is metal and the second material is a coating material.

In an example, the rigid portion is formed of a first material and the low friction portion is formed of a second material, wherein the first material is metal and the second material is a TEFLON based coating.

In an example, the pluggable electronic module includes a communications circuit within the housing, the communications circuit including a cable connector at a front end of the housing and a PCB interface at a back end of the housing.

In an example, the pluggable electronic module is an optical transceiver that includes a communications circuit within the housing, the communications circuit including a cable connector at a front end of the housing and a PCB interface at a back end of the housing.

In an example, the housing of the pluggable electronic module has length, width, and height dimensions, and wherein the low friction portion of the housing spans the width dimension of the housing.

Another example of a pluggable electronic module is disclosed. The pluggable electronic module includes a housing having a front end and a back end, a communications media interface at the front end of the housing, and a rigid portion at the back end and a low friction portion covering at least a portion of the rigid portion.

In an example, the pluggable electronic module further includes a leading edge at the back end of the housing, wherein the low friction portion of the housing covers the leading edge at the back end of the housing.

In an example, the housing including an integrated heat sink, wherein the low friction portion of the housing covers a portion of the integrated heat sink.

In an example, the rigid portion of the housing is formed of a first material and the low friction portion of the housing is formed of a second material.

Another example of a pluggable electronic module is disclosed. The pluggable electronic module includes an elongated housing having a front end and a back end, wherein the front end of the elongated housing includes a communications media interface, and the back end of the housing includes a rigid portion and a low friction portion covering at least a portion of the rigid portion.

In an example, the low friction portion of the elongated housing spans a width dimension of the housing.

Another example of a pluggable electronic module is disclosed. The pluggable electronic module includes a housing that includes a first material and a second material, wherein the second material is at a back end of the housing and configured to enable smooth insertion of the pluggable electronic module into a cage.

Other aspects in accordance with the disclosure will become apparent from the following detailed description, taken in conjunction with the accompanying drawings, illustrated by way of example of the principles of the disclosure.

### BRIEF DESCRIPTION OF THE DRAWINGS

FIG. 1A is a perspective view of a cage for a pluggable electronic module.

FIG. 1B is a perspective view of the cage from FIG. 1A with a pluggable electronic module inserted in the cage and a riding heat sink connected to the cage.

FIG. 1C is a perspective view of a cage that includes a riding heat sink connected to the cage.

FIG. 2 is a perspective view of an example of a conventional pluggable electronic module that is configured for use with a riding heat sink.

FIG. 3 is a perspective view of an example of a pluggable electronic module that includes a housing with an upper portion with a sloped leading edge that is configured to reduce damaging forces that may be generated during insertion of the pluggable electronic module into a cage.

FIG. 4 is a side view of the back end of a pluggable electronic module that includes a low friction sticker.

FIG. 5A is a cross-sectional view of the back end of a pluggable electronic module that includes a low friction sticker.

FIG. 5B is a cross-sectional view of the back end of the pluggable electronic module from FIG. 5A that shows the low friction sticker and illustrates an increased contact area that results from application of the low friction sticker.

FIG. 6 is a top view of the upper portion of a housing of a pluggable electronic module that shows a low friction sticker.

FIG. 7 is a perspective view of an example of a pluggable electronic module that includes a sloped leading edge and a low friction sticker adhered to the sloped leading edge.

FIG. 8 is a perspective view of the back end of an example of a pluggable electronic module that includes a sloped leading edge that is sized to facilitate application of an overmolding material.

FIG. 9 is a perspective view of the pluggable electronic module from FIG. 8 with a low friction material overmolded over the sloped leading edge of the upper portion of the housing.

FIG. 10 is a perspective view of an example of a pluggable electronic module that includes a sloped leading edge that is coated with a low friction material.

FIG. 11 is a perspective view of the back end of an example of a pluggable electronic module that includes an example of an integrated heat sink that is covered with a low friction material.

FIG. 12 is a perspective view of the back end of an example of a pluggable electronic module that includes another example of an integrated heat sink with fins that are covered with a low friction material.

FIG. 13 is an example of a system that includes an optical transceiver, a heatsink, a carrier PCB, a cage, and a faceplate.

FIG. 14 is an example of an optical transceiver.

FIG. 15 illustrates a computer system.

FIG. 16A is an example of a network architecture.

FIG. 16B is another example of a network architecture.

FIG. 17 is an example of a system that includes a device, a communications network, and a device.

FIG. 18 illustrates a fat tree topology for a datacenter.

FIG. 19 is an example of a fat tree topology of a network.

FIG. 20 illustrates an example data center.

FIGS. 21A and 21B illustrate a top view and a perspective view, respectively, of a transceiver module.

FIG. 22 depicts exemplary scenarios for use of an optical transceiver in accordance with some embodiments.

Throughout the description, similar reference numbers may be used to identify similar elements.

### DETAILED DESCRIPTION

It will be readily understood that the components of the examples as generally described herein and illustrated in the appended figures could be arranged and designed in a wide variety of different configurations. Thus, the following more detailed description of various examples, as represented in the figures, is not intended to limit the scope of the present disclosure, but is merely representative of various examples. While the various aspects of the examples are presented in drawings, the drawings are not necessarily drawn to scale unless specifically indicated.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present disclosure should be or are in any single example. Rather, language referring to the features and advantages is understood to mean that a specific feature, advantage, or characteristic described in connection with an example is included in at least one example of the present disclosure. Thus, discussions of the features and advantages, and similar language, throughout this specification may, but do not necessarily, refer to the same example.

Furthermore, the described features, advantages, and characteristics of the disclosure may be combined in any suitable manner in one or more embodiments. One skilled in the relevant art will recognize, in light of the description herein, that the disclosure can be practiced without one or more of the specific features or advantages of a particular embodiment. In other instances, additional features and advantages may be recognized in certain examples that may not be present in all examples of the disclosure.

Reference throughout this specification to “one example”, “an example”, or similar language means that a particular feature, structure, or characteristic described in connection with the indicated example is included in at least one embodiment of the present disclosure. Thus, the phrases “in one example”, “in an example”, and similar language throughout this specification may, but do not necessarily, all refer to the same embodiment.

A problem with some interconnect systems that include a pluggable electronic component and a heat sink is excessive wear and tear (e.g., abrasion) on both the pluggable electronic module and the heat sink during insertion of the pluggable electronic module into a cage. The wear and tear can be caused by high friction that results from a spring-loaded mechanism that applies force to the heat sink and the need for full contact between the pluggable electronic module and the heat sink for effective heat dissipation.

Typical pluggable electronic modules adhere strictly to an established industry specification (e.g., the Octal Small Form Factor Pluggable (OSFP) Multi-Source Agreement (MSA) specification) that calls for smooth surface finishes. While smooth surface finishes can reduce friction to some extent, the smooth surface finishes may not fully address the issue of variable spring force and the resulting wear and tear on the pluggable electronic component and/or on the heat sink during insertion of the pluggable electronic component into a cage.

Attempts have been made to modify the spring mechanisms to reduce the force required for insertion of a pluggable electronic component into a cage. While some progress has been made, such measures often compromise the stability and contact needed for effective heat dissipation, leading to potential overheating issues.

As disclosed herein, features of a pluggable electronic component reduce friction to allow easier insertion of the pluggable electronic component and lifting of the corresponding heat sink with less force. In an example, a low friction element is added to the pluggable electronic component to reduce friction to allow easier insertion of the pluggable electronic component and lifting of the corresponding heat sink with less force. For example, the low friction element is integrated with the housing of the pluggable electronic component. The low friction element may include a low friction sticker adhered to a portion of the housing, a low friction material such as rubber or plastic molded over a portion of the housing, or a low friction material coated onto portion of the housing. By adding a low friction element to a pluggable electronic module, friction between the pluggable electronic component and a heat sink can be reduced without compromising thermal performance. In an example, a pluggable electronic module includes a housing having a rigid portion and a low friction portion covering at least a portion of the rigid portion. The low friction portion enables smooth insertion of the pluggable electronic module into a cage, e.g., insertion that mitigates friction induced damage to the pluggable electronic module and/or to a corresponding heat sink. In an example, the rigid portion is formed of a first material such as a metal and the low friction portion is formed of a second material, such as a low friction sticker, a low friction overmolded plastic, or a low friction coating. In an example of a pluggable electronic module that is designed for a riding heat sink, the rigid portion and the low friction portion are at a leading edge of a back end of the pluggable electronic module and in an example of a pluggable electronic module that is designed with an integrated heat sink, the rigid portion is part of the integrated heat sink and the low friction portion is formed over a portion of the integrated heat sink. Moreover, by using the pluggable electronic module described therein, a maximum pressure of the heat sink may be applied, thereby enhancing thermal performance without increasing the insertion force required as specified.

A low friction element as disclosed herein significantly reduces the friction encountered during the insertion process. Reducing friction during the insertion process is important at least because friction caused by a spring-loaded mechanism and the need for full contact between a pluggable electronic module and a heat sink for heat dissipation can lead to rapid wear and tear on the pluggable electronic component and/or on the heat sink. By lowering the friction between a pluggable electronic component and a heat sink during the insertion process, damage such as abrasions on the pluggable electronic module and/or on the heat sink can be avoided, which can extend the lifespan of the components, reducing the frequency of replacement and maintenance. In systems with pluggable electronic components and corresponding heat sinks, where multiple heat sinks may be influenced together using a single spring, the spring force may vary depending on the position of a particular heat sink relative to the spring. Integrating a low friction element into the housing of a pluggable electronic module as disclosed herein helps to mitigate negative effects of the variable spring force, ensuring smoother insertion of the pluggable electronic module into a cage and reducing undesired friction that may otherwise be generated.

Various techniques for reducing friction between a pluggable electronic module and a heat sink are disclosed herein. Examples of techniques include:
1) Adding a low friction sticker to the housing: For example, applying a sticker with a low friction coefficient to the back end of a pluggable electronic module and/or to a portion of an integrated heat sink of a pluggable electronic module.
2) Creating a dual-material housing (e.g., backshell): For example, using over-molding to create a back end of the housing that includes two materials, for example, adding a low friction material to an upper portion of the back end of the housing.
3) Applying a low friction coating: For example, coating a portion of the back end of the housing of a pluggable electronic module with a material that has a low friction coefficient, and/or coating a portion of an integrated heat sink of a pluggable electronic module with a material that has a low friction coefficient.

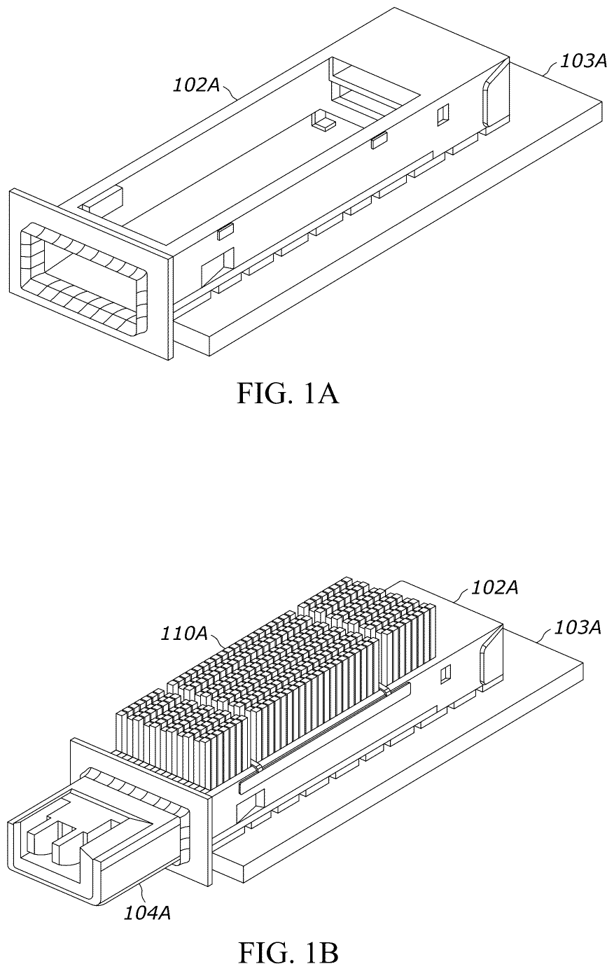

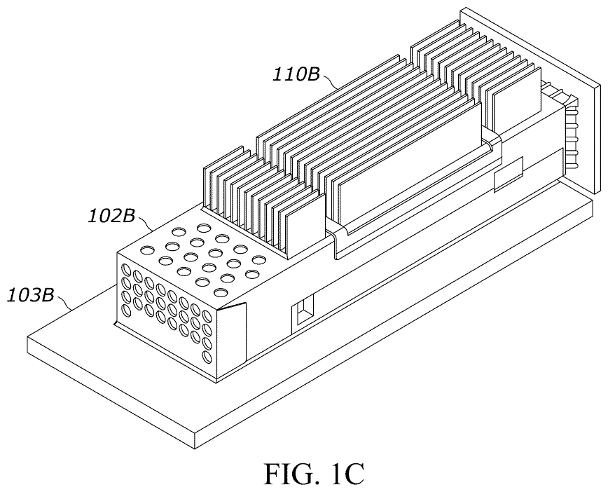

FIG. 1A is a perspective view of a cage 102A for a pluggable electronic module. The cage is attached to a substrate 103A such as a printed circuit board (PCB), and is configured to support use of a riding heat sink. In an example, the cage conforms to the OSFP specification.

FIG. 1B is a perspective view of the cage 102A from FIG. 1A with a pluggable electronic module 104A inserted in the cage and a riding heat sink 110A connected to the cage. In an example, the pluggable electronic module is an optical transceiver.

FIG. 1C is a perspective view of a cage 102B that includes a riding heat sink 110B connected to the cage. The cage 102B is attached to a substrate 103B, such as a PCB.

The techniques described herein are applicable to pluggable electronic modules that utilize a heat sink as described above with reference to FIG. 1A-1C. The techniques described herein are also applicable to pluggable electronic modules that have an integrated heat sink.

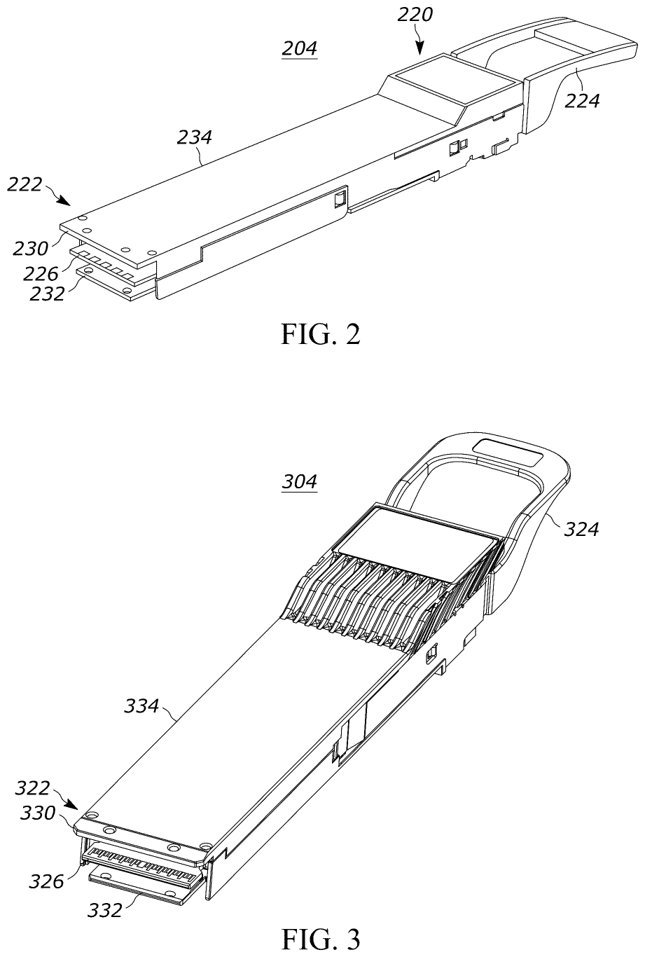

FIG. 2 is a perspective view of an example of a conventional pluggable electronic module 204 that is configured for use with a riding heat sink. In the example of FIG. 2, the pluggable electronic module is an OSFP riding heat sink (OSFP-RHS) module as specified in the OSFP multi-source agreement (MSA). As described in the OSPF MSA, the pluggable electronic module has a front end 220 and a back end 222. The front end of the pluggable electronic module includes a cable connector (not visible) and a pull tab 224 and the back end of the pluggable electronic module includes a signal pad 226 (e.g., a PCB interface), an upper portion 230, and a lower portion 232 of a housing 234 of the pluggable electronic module. As shown in the example of FIG. 2, the leading edges of the upper and lower portions of the housing at the back end 222 of the pluggable electronic module protrude from the main body of the housing. In some cases, insertion of a conventional pluggable electronic module, such as the pluggable electronic module described with reference to FIG. 2, into a cage, such as the cages described with reference to FIG. 1A-1C, can cause damage to the heat sink and/or to a thermal interface material (TIM) that is attached to a pedestal of the heat sink and exposed at an upper portion of the cage. For example, protruding edges of the leading edge of the pluggable electronic module can damage the thermal interface material, particularly when the pluggable electronic module is inserted into the cage at an angle, e.g., a pitch angle relative to the cage. However, in accordance with an example of the current disclosure, a pluggable electronic module includes a housing having a rigid portion and a low friction portion covering at least a portion of the rigid portion. The low friction portion of the housing is configured to reduce damaging forces that may be generated during insertion of the pluggable electronic module into a cage, which ensures smoother insertion of the pluggable electronic module into the cage and reduces additional friction that may otherwise be generated during the insertion process. In an example, the back end of the housing has a sloped leading edge that further reduces damaging forces that may be generated during insertion of a pluggable electronic component into a cage.

FIG. 3 is a perspective view of an example of a pluggable electronic module 304 that includes an upper portion 330 with a sloped leading edge that is configured to reduce damaging forces that may be generated during insertion of the pluggable electronic module into a cage. The back end 322 of the pluggable electronic module of FIG. 3 also includes a signal pad 326 and a lower portion 332 of the housing.

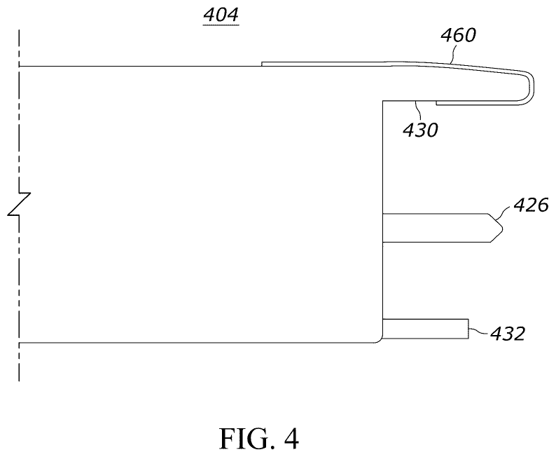

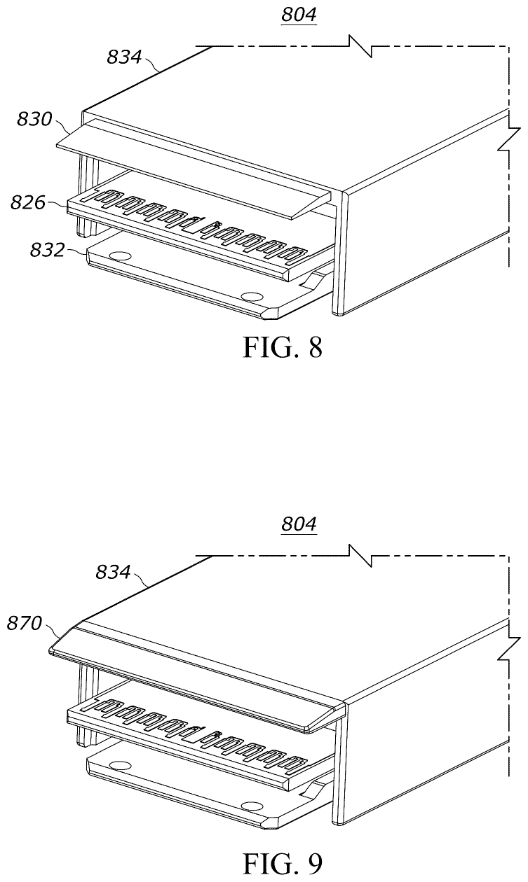

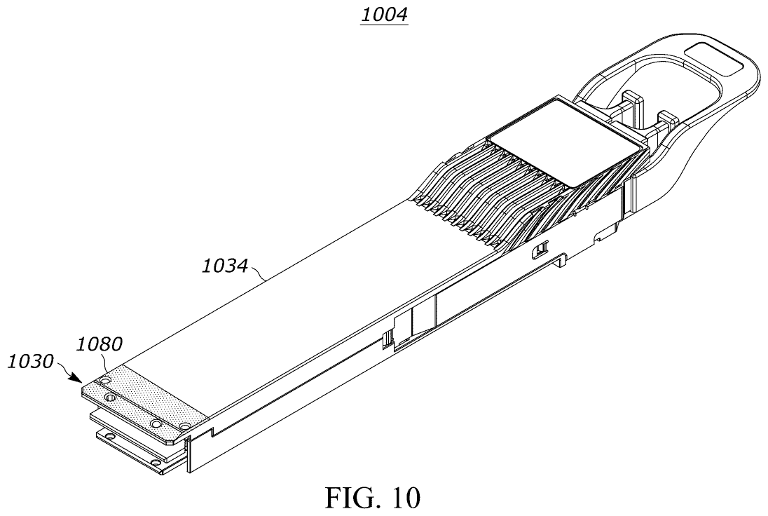

Examples of different techniques for reducing friction between a pluggable electronic module and a heat sink are described below with reference to FIG. 4-12. In particular, a technique that involves a low friction sticker is described with reference to FIG. 4-7, a technique that involves overmolding is described with reference to FIGS. 8 and 9, and a technique that involves a low friction coating is described with reference to FIG. 10-12.

In an example, the rigid portion of the housing is metal and the low friction portion of the housing is a low friction sticker. For example, a sticker with a low friction coefficient is adhered to the leading edge of the back end of a pluggable electronic module to cover the leading edge of the back end. For example, the sticker may be wrapped around the leading edge.

FIG. 4 is a side view of the back end of a pluggable electronic module 404 that shows an upper portion 430 of the housing, a lower portion 432 of the housing, and a PCB interface 426. FIG. 4 also shows a low friction sticker 460 that is adhered to the upper portion of the housing. In the example, of FIG. 4, the upper portion of the housing is formed of a rigid material such as metal and the low friction portion of the housing is formed of a low friction material such as Kapton, Formex, Mylar, PVC, or ultra-high-molecular-weight (UHMW) polyethylene that is adhered to the rigid portion of the housing with an adhesive. In one example, a low friction sticker formed of UHMW polyethylene has provided desirable performance.

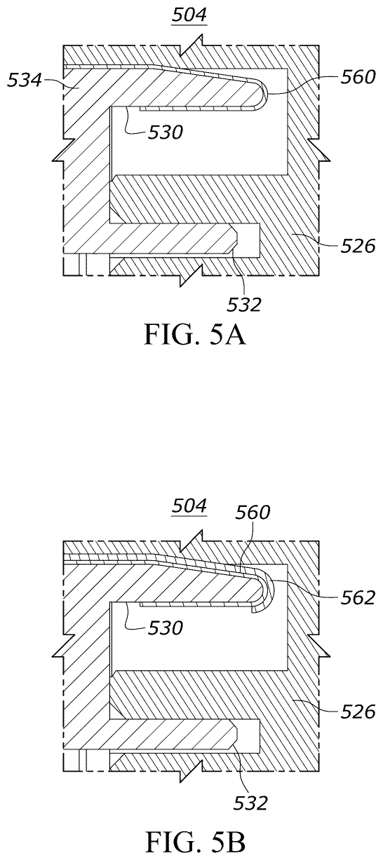

FIG. 5A is a cross-sectional view of the back end of a pluggable electronic module 504 that shows an upper portion 530 of the housing 534 and a lower portion 532 of the housing relative to a host connector housing 526. FIG. 5A also shows the low friction sticker 560 adhered to the upper portion of the housing and FIG. 5A shows that there is sufficient clearance between the low friction sticker and the host connector housing 526. In the example, of FIG. 5A, the low friction sticker is formed of a low friction material such as Kapton, Formex, Mylar, PVC, or UHMW polyethylene that is adhered to the rigid portion of the housing with an adhesive.

FIG. 5B is a cross-sectional view of the back end of the pluggable electronic module 504 from FIG. 5A that shows the low friction sticker 560 and illustrates an increased contact area 562 that results from application of the low friction sticker to the upper portion 530 of the housing. As illustrated in FIG. 5B, contact between the low friction sticker and a corresponding heat sink is expected to occur across the highlighted range.

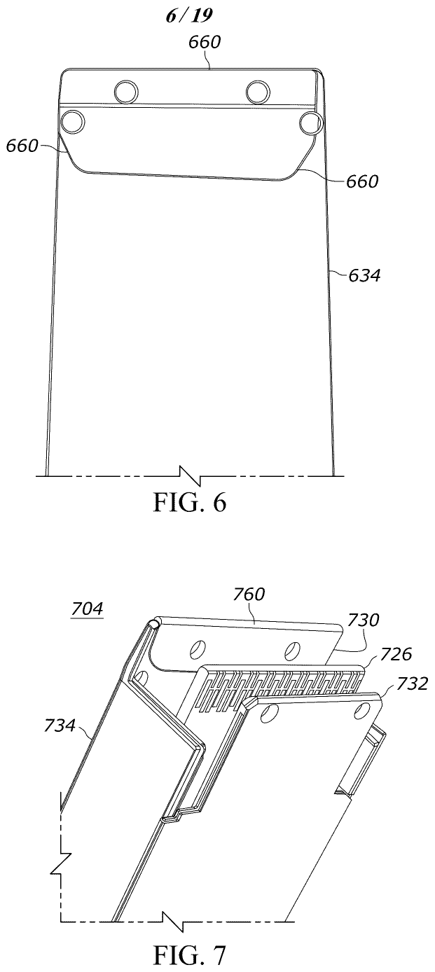

FIG. 6 is a top view of the upper portion of a housing 634 (e.g., upper shell of a backshell) of a pluggable electronic module that shows a low friction sticker 660 adhered to the upper portion of the housing. The portion of the low friction sticker that covers the top surface of the upper portion of the housing provides a low friction interface between the pluggable electronic module and a heat sink during an early part of the insertion of the pluggable electronic module into a cage, particularly when the pluggable electronic module is inserted at a pitch angle. As shown in FIG. 6, the low friction sticker spans the width dimension of the housing 634.

FIG. 7 is a perspective view of an example of a pluggable electronic module 704 that includes a sloped leading edge 730 and a low friction sticker 760 adhered to the sloped leading edge to reduce damaging forces that may be generated during insertion of the pluggable electronic module into a cage. As shown in FIG. 7, the low friction sticker covers the sloped leading edge 730 of the housing. In the example of FIGS. 6 and 7, the low friction sticker is formed of a low friction material such as Kapton, Formex, Mylar, PVC, or UHMW polyethylene that is adhered to the rigid portion of the housing with an adhesive. In one example, the low friction portion of the sticker is formed of UHMW polyethylene, which has provided desirable performance. The back end of the pluggable electronic module of FIG. 7 also includes a signal pad 726 and a lower portion 732 of the housing 734.

In an example, the rigid portion of the housing of a pluggable module is metal (e.g., aluminum, copper, steel, or zamak) and the low friction portion of the housing of the pluggable electronic module is an overmolded material. For example, over-molding is used to create a back end of the housing that includes a leading edge with a low friction overmolded material.

FIG. 8 is a perspective view of the back end of an example of a pluggable electronic module 804 that includes a sloped leading edge of an upper portion 830 of the housing 834, a PCB interface 826, and a lower portion 832 of the housing. The sloped leading edge of the upper portion of the housing is sized to facilitate application of an overmolding material using, for example, an overmolding process.

FIG. 9 is a perspective view of the pluggable electronic module 804 from FIG. 8 with a low friction material 870 overmolded over the sloped leading edge of the upper portion of the housing. In an example, the rigid portion of the housing (not visible in FIG. 8) is formed of a first material such as metal and the low friction portion of the housing is formed of a second material, for example, a low friction molded material such as thermoplastic polyurethane (TPU), thermoplastic elastomer (TPE), polyoxymethylene (POM), silicone, or polyamide (Nylon). Any material having the following properties may be used: flexible or rigid, abrasion-resistant material with a low friction coefficient, strong and durable, heat-resistant material, lightweight, protection against rust, corrosion, and external damage. As shown in FIG. 9, the low friction material (e.g., the overmolded material) covers the sloped leading edge of the housing. In one example, the overmolded portion of the housing is formed of Nylon, which has provided desirable performance. As shown in the example of FIG. 9, the overmolded material has an upper surface that is flush with an upper surface of the housing 834 so that the pluggable electronic module has a continuous and smooth upper surface that enables the pluggable electronic module to easily slide by a surface of a heat sink with little to no damaging friction. In the example of FIG. 6, the overmolded portion spans the width dimension of the housing 834.

In an example, the rigid portion of the housing is metal and the low friction portion of the housing is a low friction coating. For example, a portion of the back end of the housing of a pluggable electronic module is coated with a material that has a low friction coefficient.

FIG. 10 is a perspective view of an example of a pluggable electronic module 1004 that includes a sloped leading edge 1030 that is coated with a low friction material 1080 to reduce damaging forces and/or friction that may be generated during insertion of the pluggable electronic module into a cage. For example, the rigid portion of the housing is metal and the low friction portion of the housing is a coating that is coated over the metal portion of the housing. In the example of FIG. 10, the low friction coating covers a portion of the upper surface of the back end of the pluggable electronic module. The low friction coating may be, for example, polyurethane, acrylic, nitrile rubber, silicone, or Black-T (Teflon-based coating). In one example, the coating is a Black-T (Teflon-based) coating, which has provided desirable performance. In the example of FIG. 10, the low friction coating spans the width dimension of the housing 1034. By adding the low friction coating to the pluggable electronic module, friction between the housing of the pluggable electronic component and a heat sink can be reduced while the pluggable electronic module is inserted into a cage without compromising thermal performance. In one example, the housing 1034 of the pluggable electronic module 1004 may have an lower shell piece and an upper shell piece that are attached together and the coating may be applied to an end portion of the upper shell piece before the upper shell piece and the lower shell piece of the housing are attached to each other.

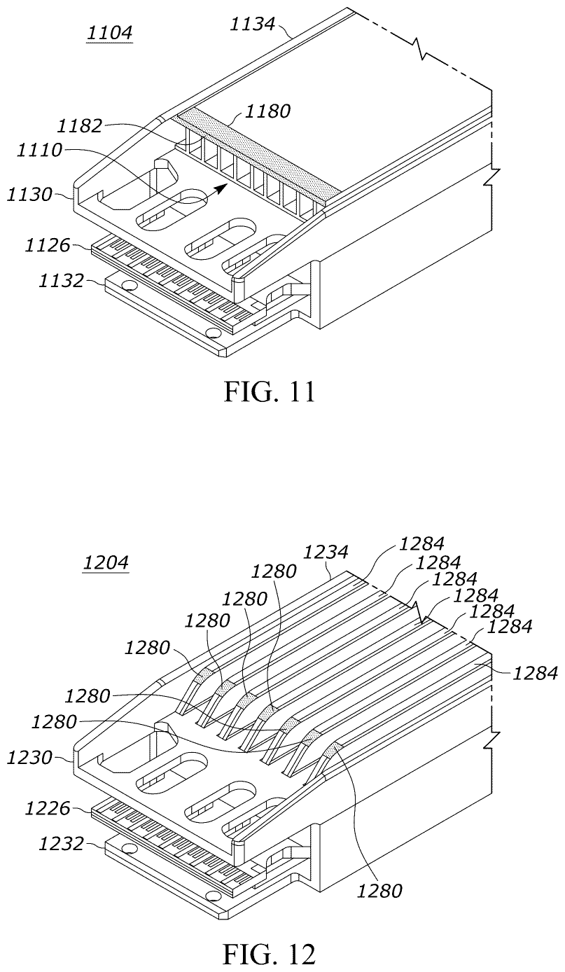

FIG. 11 is a perspective view of the back end of an example of a pluggable electronic module 1104 that includes an example of an integrated heat sink 1110 (e.g., a closed top integrated heat sink), a PCB interface 1126, an upper portion 1130, and a lower portion 1132 of the housing 1134. In the example of FIG. 11, the top trailing edge 1182 of the closed top heat sink is covered with a low friction material 1180. For example, the top trailing edge of the closed top heat sink is covered with a low friction coating such as a Black-T (Teflon-based) coating. In other examples, the top trailing edge of the closed top heat sink is covered with a low friction sticker or a low friction overmolding. Covering the top trailing edge of the closed top heat sink reduces damaging forces/friction that may be generated during insertion of the pluggable electronic module into a cage.

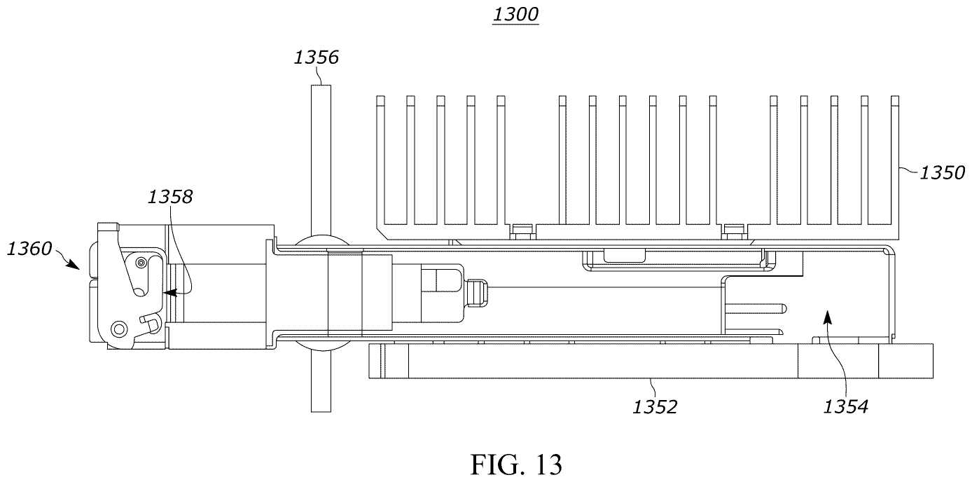

FIG. 12 is a perspective view of the back end of an example of a pluggable electronic module 1204 that includes another example of an integrated heat sink with fins 1284 (e.g., an open top integrated heat sink), a PCB interface 1226, an upper portion 1230, and a lower portion 1232 of the housing 1234. In the example of FIG. 12, the rounded edges of fins of the open top heat sink are covered with a low friction material 1280. For example, the rounded edges of the fins of the open top heat sink are covered with a low friction coating such as a Black-T (Teflon-based) coating. In other examples, the rounded edges of the fins of the open top heat sink are covered with a low friction sticker or a low friction overmolding. Covering the rounded edges of the fins of the open top heat sink with low friction material reduces damaging forces and/or friction that may be generated during insertion of the pluggable electronic module into a cage.

As is known in the field, the pluggable electronic modules described herein may be a communications interface such as an optical transceiver that provides an interconnect between a communications media such as an optical fiber or twisted pair wires, and a computer system such as a host computer. For example, the pluggable electronic module includes a communications circuit within the housing, a communications media interface (e.g., a cable connector) at the front end of the housing, which is coupled to the communications circuit, and a printed circuit board (PCB) interface at the back end of the housing, which is also coupled to the communications circuit. In an example operation, the pluggable electronic module is inserted into a cage, wherein the PCB interface is coupled to a complementary interface in the cage and the cable connector is coupled to an optical fiber. The communications circuit provides coupling of digital data between the cable connector and the PCB interface. As used herein, the interconnect features may be conductive portions of a circuit board. For instance, the interconnect features may include metal traces, plated and non-plated through-holes, solder points, transmission lines, and electrically-insulating circuit board material over which such copper traces and solder points may lie. An interconnect feature may pass along sides and across the circuit board to contact between computing features, such as a chip to chip interconnect, an NVlink® interconnect, a PCIe® high speed communication interconnect, among other interconnects that may exist on a circuit board.

The techniques described herein involve a pluggable electronic module that includes an elongated housing with a rigid portion and a low friction portion covering at least a portion of the rigid portion and the techniques are applicable to various types of pluggable electronic modules, including, for example, a pluggable electronic module with an integrated heat sink and a pluggable electronic module with a riding heat sink (e.g., an OSFP-RHS module as specified in the OSFP MSA).

In an example, the front end of a pluggable module or the front end of the housing of the pluggable electronic module is a portion of the pluggable electronic module or a portion of the hosing of the pluggable electronic module that is at or near a front edge of the pluggable electronic module or at or near a front edge of the housing (e.g., within about 20% of the total length of pluggable electronic module from the front edge) and the back end of a pluggable module or the back end of the housing of the pluggable electronic module is a portion of the pluggable electronic module or a portion of the hosing of the pluggable electronic module that is at or near a back edge of the pluggable electronic module or at or near a back edge of the housing (e.g., within about 20% of the total length of pluggable electronic module from the back edge).

The term low friction as used herein, may refer to a property of a material, coating, or surface treatment characterized by a reduced coefficient of friction relative to another material, such as a metal housing, which decreases resistance to relative motion between contacting surfaces. In the context of a pluggable electronic component such as a pluggable optical transceiver module, a low friction element (e.g., the low friction portion of the housing) of the pluggable electronic module is an element that has a lower coefficient of friction than the metal portion of the housing (e.g., the rigid portion of the housing) of the pluggable electronic module. The low friction element that is added to the metal housing of the pluggable electronic module reduces friction between the pluggable electronic module and a corresponding cage. The low friction element facilitates the insertion of the pluggable electronic module into the cage and the removal of the pluggable electronic module from the cage, thereby reducing insertion force and mechanical wear and enhancing operational reliability over repeated insertion/removal cycles.

FIG. 13 is an example of a system that includes an optical transceiver 1300, a heatsink 1350, a carrier PCB 1352, a cage 1354, and a faceplate 1356. The optical transceiver is inserted into the cage and includes a latching mechanism 1358 and an optical connector 1360.

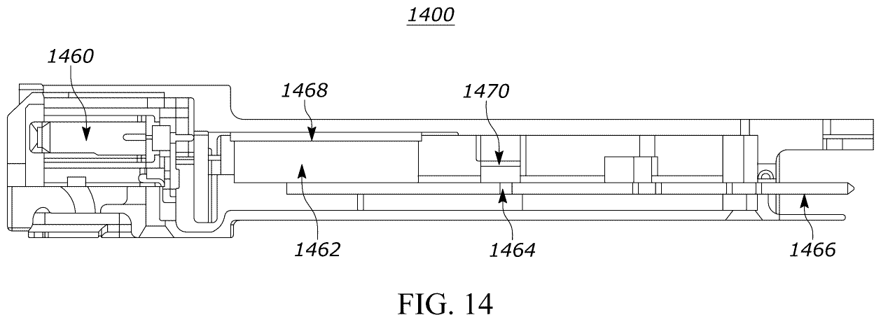

FIG. 14 is an example of an optical transceiver 1400 that includes an optical connector 1460, transceiver optics components 1462, an internal PCB with devices 1464, and a PCB edge connector 1466. The optical transceiver also includes a thermal interface material 1468 affixed near an optical transceiver IC device and a thermal interface material 1470 affixed near the devices on the internal PCB.

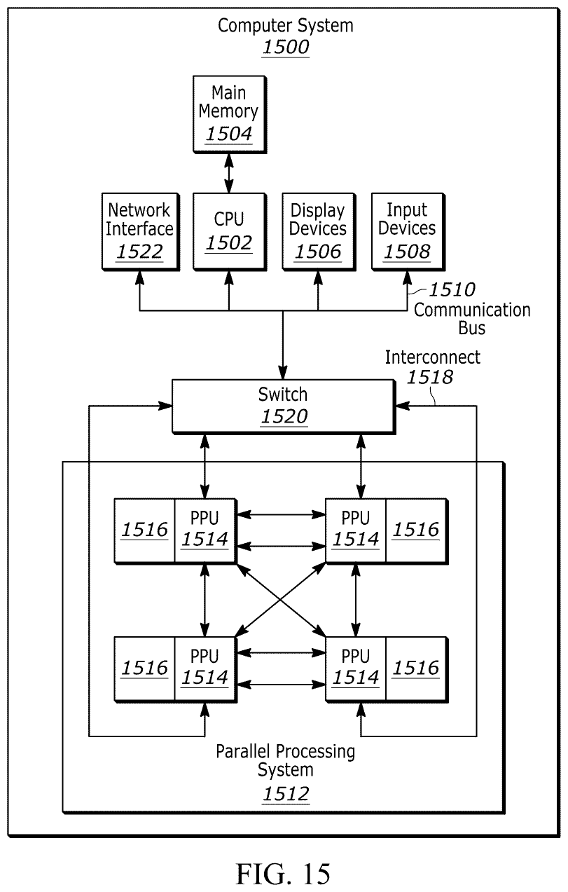

FIG. 15 illustrates a computer system 1500, according to at least one embodiment. In at least one embodiment, computer system 1500 is configured to implement various processes and methods described throughout this disclosure.

In at least one embodiment, computer system 1500 comprises, without limitation, at least one central processing unit (“CPU”) 1502 that is connected to a communication bus 1510 implemented using any suitable protocol, such as PCI (“Peripheral Component Interconnect”), peripheral component interconnect express (“PCI-Express”), AGP (“Accelerated Graphics Port”), HyperTransport, or any other bus or point-to-point communication protocol(s). In at least one embodiment, computer system 1500 includes, without limitation, a main memory 1504 and control logic (e.g., implemented as hardware, software, or a combination thereof) and data are stored in main memory 1504 which may take form of random access memory (“RAM”). In at least one embodiment, a network interface subsystem (“network interface”) 1522 provides an interface to other computing devices and networks for receiving data from and transmitting data to other systems from computer system 1500.

In at least one embodiment, computer system 1500, in at least one embodiment, includes, without limitation, input devices 1508, parallel processing system 1512, and display devices 1506 which can be implemented using a conventional cathode ray tube (“CRT”), liquid crystal display (“LCD”), light emitting diode (“LED”), plasma display, or other suitable display technologies. In at least one embodiment, user input is received from input devices 1508 such as keyboard, mouse, touchpad, microphone, and more. In at least one embodiment, each of foregoing modules can be situated on a single semiconductor platform to form a processing system.

In at least one embodiment, computer programs in form of machine-readable executable code or computer control logic algorithms are stored in main memory 1504 and/or secondary storage. Computer programs, if executed by one or more processors, enable system 1500 to perform various functions in accordance with at least one embodiment. memory 1504, storage, and/or any other storage are possible examples of computer-readable media. In at least one embodiment, secondary storage may refer to any suitable storage device or system such as a hard disk drive and/or a removable storage drive, representing a floppy disk drive, a magnetic tape drive, a compact disk drive, digital versatile disk (“DVD”) drive, recording device, universal serial bus (“USB”) flash memory, etc. In at least one embodiment, architecture and/or functionality of various previous figures are implemented in context of CPU 1502; parallel processing system 1512; an integrated circuit capable of at least a portion of capabilities of both CPU 1502; parallel processing system 1512; a chipset (e.g., a group of integrated circuits designed to work and sold as a unit for performing related functions, etc.); and any suitable combination of integrated circuit(s).

In at least one embodiment, architecture and/or functionality of various previous figures are implemented in context of a general computer system, a circuit board system, a game console system dedicated for entertainment purposes, an application-specific system, and more. In at least one embodiment, computer system 1500 may take form of a desktop computer, a laptop computer, a tablet computer, servers, supercomputers, a smart-phone (e.g., a wireless, hand-held device), personal digital assistant (“PDA”), a digital camera, a vehicle, a head mounted display, a hand-held electronic device, a mobile phone device, a television, workstation, game consoles, embedded system, and/or any other type of logic.

In at least one embodiment, parallel processing system 1512 includes, without limitation, a plurality of parallel processing units (“PPUs”) 1514 and associated memories 1516. In at least one embodiment, PPUs 1514 are connected to a host processor or other peripheral devices via an interconnect 1518 and a switch 1520 or multiplexer. In at least one embodiment, parallel processing system 1512 distributes computational tasks across PPUs 1514 which can be parallelizable, for example, as part of distribution of computational tasks across multiple graphics processing unit (“GPU”) thread blocks. In at least one embodiment, memory is shared and accessible (e.g., for read and/or write access) across some or all of PPUs 1514, although such shared memory may incur performance penalties relative to use of local memory and registers resident to a PPU 1514. In at least one embodiment, operation of PPUs 1514 is synchronized through use of a command such as_syncthreads( ), wherein all threads in a block (e.g., executed across multiple PPUs 1514) to reach a certain point of execution of code before proceeding.

Datacenters and other networking systems may include connections between datacenters, switch systems, servers, racks, and devices in order to provide for signal transmission between one or more of these elements. These connections may be made using cables, transceivers, interconnects, interposers, and connector assemblies. For high bandwidth applications and/or connections over long distances, high powered optical communications may be preferred to ensure signal transmission integrity.

Datacenters may include multiple network switches in a particular topology, such as a fat tree topology, a slim fly topology, a dragonfly topology, multi-level fat-trees, fat-flys, Benes, Clos, meshes, and tori and/or the like. The specifications and makeup of the network switches in the topology affects the overall network performance (e.g., bandwidth capability) of the datacenter.

Datacenters are the storage and data processing hubs of the internet. The massive deployment of cloud applications is causing datacenters to expand exponentially in size, stimulating the development of faster switches than can cope with the increasing data traffic inside the datacenter. Current state-of-the-art switches are capable of handling 12.8 Tb/s of traffic by employing electrical switches in the form of application specific integrated circuits (ASICs) equipped with 256 data lanes, each operating at 50 Gb/s. Such switching ASICs typically consume as much as 400 W, and the power consumption of the optical transceiver interfaces attached to each ASIC is comparable. To keep pace with traffic demand, switch capacity doubles approximately every two years. To date, this rapid scaling has been made possible by exploiting advances in manufacturing (e.g., CMOS techniques), collectively described by Moore's law (i.e., the observation that the number of transistors in a dense integrated circuit doubles about every two years). However, in recent years there are strong indications of Moore's law slowing down, which raises concerns about the capability to sustain the target scaling rate of switch capacity. As a result, alternative technologies are being investigated.

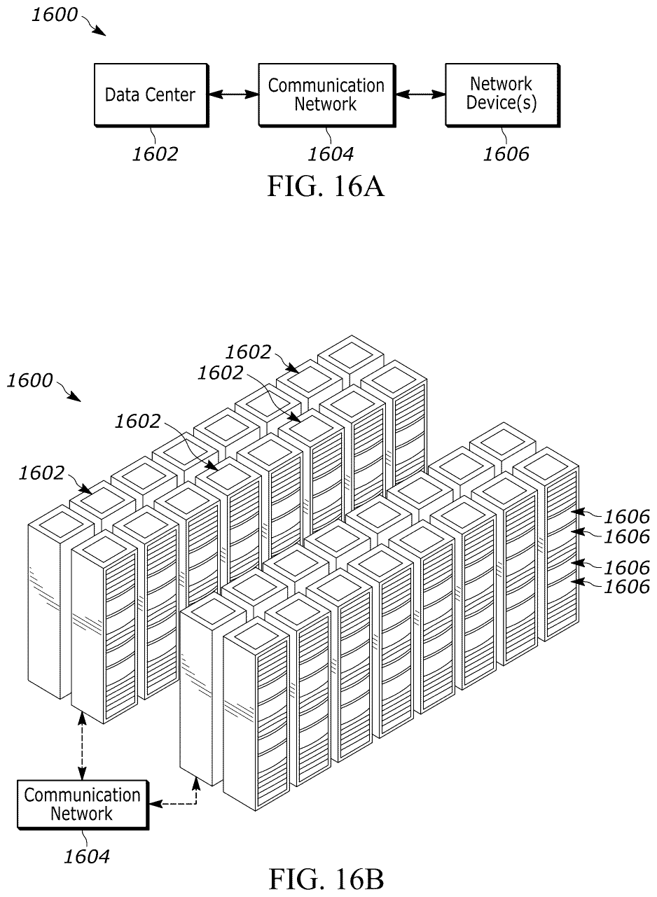

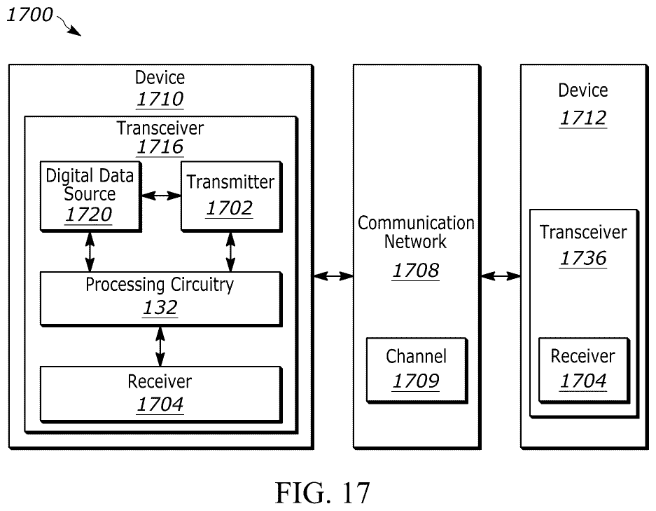

As described above, datacenters, high performance computing clusters, and/or the like are often formed of various computing components or networked devices, and communication networks formed of electrical and/or optical devices may be used to enable communication between the networked devices forming these implementations. With reference to FIGS. 16A-16B, for example, a network architecture 1600 may include a datacenter 1602, a communication network 1604, and network device(s) 1606. The network architecture 1600 may illustrate a general computing architecture within which more specific systems and/or subsystems may function. Although described hereinafter with reference to a network architecture 1600 and/or datacenter 1602 within which the embodiments of the present disclosure may be implemented, the present disclosure contemplates that the transceiver resiliency devices and techniques described herein may be applicable to any communication implementation without limitation.

For example, the datacenter 1602 may be a centralized facility designed to house computing resources and related components. The datacenter 1602 may operate to support the infrastructure required for advanced computational tasks, for efficient, secure, and reliable operations. The datacenter 1602 may include the building and structural components, including power supplies, cooling systems, fire suppression systems, and physical security measures that are configured to maintain optimal operating conditions and/or protect the equipment from environmental hazards and unauthorized access. An example datacenter 1602 may include high-performance servers or compute nodes, often arranged in racks, such as those illustrated in FIG. 16B, and connected through high-speed networks as described herein. These servers may include processors (e.g., central processing units (CPUs), graphics processing units (GPUs), data processing units (DPUs) and/or the like), memory (e.g., RAM), and storage solutions (e.g., hard disk drives (HDDs), solid state drives (SSDs), and/or the like. The hardware configuration may be designed for parallel processing and high throughput, catering to the demands of high-performance computing (HPC) applications.

The datacenter 1602 may include high-speed network equipment, such as network switches, routers, firewalls, and/or the like to facilitate fast and secure data transmission within the datacenter 1602 (e.g., between the servers or compute nodes) and between external networks. The datacenter 1602 may facilitate communication between servers or compute nodes through a network topology that ensures efficient data exchange, minimizes latency, and maximizes bandwidth. The network topology may dictate how various network devices, such as switches and routers, are interconnected for data flow. By implementing an effective network topology, the datacenter 1602 may support high-performance computing tasks. Examples of various network topologies may include hierarchical networking topologies such as the fat tree topology, Slim Fly topology, Dragonfly topology, and/or the like.

The communication network 1604 may communicably couple the datacenter 1602 with network device(s) 1606 and other external devices for data exchange and connectivity. Examples of the communication network 1604 may include an Internet Protocol (IP) network, an Ethernet network, an InfiniBand (IB) network, a Fibre Channel network, the Internet, a cellular communication network, a wireless communication network, combinations thereof (e.g., Fibre Channel over Ethernet), variants thereof, and/or the like. The ability of the communication network 1604 to incorporate multiple network types and configurations may allow the datacenter 1602 to adapt to diverse application needs, from general data communication to specialized HPC tasks. As described herein, the communication network 1604 may leverage various optical components to establish communication links (e.g., communicably couple) between components in the architecture 1600. As such, the communication network 1604 may include various optical devices, transceivers, modules, and/or the like that are configured to generate optical signals (e.g., provide optical transmitter functionality) and/or receive optical signals (e.g., provide optical receiver functionality).

The network device(s) 1606 may include a variety of computing devices capable of transmitting and receiving signals over the communication network 1604. The network device(s) 1606 may range from personal computing devices to complex server configurations. Examples include Personal Computers (PCs), laptops, tablets, smartphones, and servers. The network device(s) 1606 may facilitate user interactions with the datacenter 1602, allowing for data input, retrieval, and processing from remote locations. In addition to individual computing devices, the network device(s) 1606 may also include collections of servers or additional datacenters. For instance, these could be other datacenters similar to or the same as datacenter 1602. Such an interconnection may allow for the formation of a distributed computing environment for improved redundancy, load balancing, and disaster recovery capabilities. By linking multiple datacenters, the network architecture 1600 may leverage geographically dispersed resources, optimizing performance and ensuring high availability.

As described herein, the datacenter 1602 and/or the network device(s) 1606 may include storage devices and processing circuitry for executing computing tasks, such as controlling the flow of data internally and over the communication network 1604. The processing circuitry may include software, hardware, or a combination thereof. For example, the processing circuitry may include a memory containing executable instructions and a processor (e.g., a microprocessor) that executes these instructions. The memory may correspond to any suitable type of memory device or collection of memory devices configured to store instructions. Non-limiting examples of suitable memory devices include Flash memory, Random Access Memory (RAM), Read Only Memory (ROM), variants thereof, combinations thereof, or similar technologies. In specific embodiments, the memory and processor may be integrated into a common device, such as a microprocessor with integrated memory. Additionally, or alternatively, the processing circuitry may comprise hardware components, such as an application-specific integrated circuit (ASIC). Other non-limiting examples of processing circuitry include Integrated Circuit (IC) chips, CPUs, GPUs, microprocessors, Field Programmable Gate Arrays (FPGAs), collections of logic gates or transistors, resistors, capacitors, inductors, and diodes. Some or all of the processing circuitry may be provided on a Printed Circuit Board (PCB) or a collection of PCBs. It should be appreciated that any appropriate type of electrical component or collection of electrical components may be suitable for inclusion in the processing circuitry.

In addition, although not explicitly shown, the present disclosure contemplates that the datacenter 1602 and network device(s) 1606 may include one or more communication interfaces for facilitating wired and/or wireless communication between one another and other unillustrated elements of the network architecture 1600. These communication interfaces may include a variety of technologies, including but not limited to Ethernet ports, fiber optic connections, Wi-Fi® transceivers, Bluetooth® modules, and cellular communication modules for integration and interoperability among the various components within the network architecture 1600.

Furthermore, the present disclosure contemplates that the network architecture 1600 may include additional components and functionalities. For example, the network architecture may include, without limitation, additional processing units, specialized accelerators (such as Tensor Processing Units or TPUs), enhanced security modules, and redundant power supplies. The inclusion of these elements may be intended to ensure that the network architecture 1600 is robust, scalable, and capable of meeting diverse operational requirements. Any variations, modifications, or adaptations of the described elements that fall within the spirit and scope of the disclosure are considered to be encompassed by the present disclosure. This includes any combinations, sub-combinations, or enhancements of the various described elements to achieve improved performance, reliability, and efficiency in the network architecture 1600.

In high-capacity datacenter networks, such as those illustrated in FIGS. 16A-16B, the communication network 1604 may leverage optical transceivers that transmit and receive optical signals over optical fibers or other optical communication mediums in order to establish connection between devices in the architecture 1600.

In at least one example embodiment, the datacenter 1602 corresponds to a collection of network devices, such as network switches (e.g., Ethernet switches, IP routers, multiservice platforms, various transmission network elements, legacy communication equipment, or in any other suitable communication system) connected with a collection of servers or compute nodes.

A switch fabric serves to transfer the data between the switch ports. A switch fabric comprises one or more interconnect circuits, which may be arranged in various switch fabric architectures, e.g., m*m crossbar, Banyan, Benes, Omega, Clos, multi-plane, STS, TST, shared memory, buffered crossbar, any other suitable blocking or non-blocking architecture, or any applicable mixed architecture thereof. A switch fabric is realized in typical embodiments by hardware, which may comprise Field-Programmable Gate Arrays (FPGAs) and/or Application-Specific Integrated Circuits (ASICs), and in some implementations also bus interconnects. The datacenter 1602 may adhere to a networking topology (e.g., a hierarchal networking topology), such as a fat tree topology, a Slim Fly topology, a Dragonfly topology, and/or the like. The datacenter 1602 routes traffic amongst the network switches and servers therein, and at least one layer of the topology in the datacenter 1602 is coupled to the communication network 1604 to allow networking traffic to flow between the datacenter 1602 and the network device(s) 1606.

The communication network 1604 may communicably couple the datacenter 1602 with network device(s) 1606 and other external devices for data exchange and connectivity. Examples of the communication network 1604 may include an Internet Protocol (IP) network, an Ethernet network, an InfiniBand (IB) network, a Fibre Channel network, the Internet, a cellular communication network, a wireless communication network, combinations thereof (e.g., Fibre Channel over Ethernet), variants thereof, and/or the like.

Each type of network offers specific advantages tailored to different operational requirements. For instance, an IP network or Ethernet network may provide widespread compatibility and ease of integration, supporting various protocols and applications across the datacenter and the network device(s) (and/or external devices). An InfiniBand network may offer high throughput and low latency, ideal for HPC environments where rapid data transfer and minimal delay are required. Fibre Channel networks may be employed for their robust performance in storage area networks (SANs), ensuring fast and reliable access to storage resources. Cellular and wireless communication networks may be used to extend connectivity to remote or mobile devices for increased flexibility and accessibility.

FIG. 17 is an example of a system 1700 that includes a device 1710, and communications network 1708, and a device 1712. In one specific but non-limiting example, the communication network 1708 is a network that enables data transmission between the devices 1710 and 1712 using data signals (e.g., digital, optical, wireless signals). In the example of FIG. 17, the device 1710 includes a digital data source 1720, a transmitter 1702, processing circuitry 1732, and a receiver 1704. The communications network 1708 includes a channel 1709, and the device 1712 includes a transceiver 1736 with a receiver 1704.

Examples of the communication network 1708 that may be used to connect a datacenter and the network device(s) 1712 include an Internet Protocol (IP) network, an Ethernet network, an InfiniBand (TB) network, a Fibre Channel network, the Internet, a cellular communication network, a wireless communication network, combinations thereof (e.g., Fibre Channel over Ethernet), variants thereof, and/or the like.

The network device(s) 1710 and 1712 may include a variety of computing devices capable of sending and receiving signals over the communication network 108. The network device(s) can range from personal computing devices to complex server configurations. Examples include Personal Computers (PCs), laptops, tablets, smartphones, and servers. The network device(s) may facilitate user interactions with the datacenter, allowing for data input, retrieval, and processing from remote locations. In addition to individual computing devices, the network device(s) may also include collections of servers or additional datacenters. For instance, these could be other datacenters similar to or the same as datacenter. Such an interconnection may allow for the formation of a distributed computing environment for improved redundancy, load balancing, and disaster recovery capabilities. By linking multiple datacenters, the data center environment 100 can leverage geographically dispersed resources, optimizing performance and ensuring high availability.

The one or more network devices 1710 and 1712 may include one or more of Personal Computer (PC), a laptop, a tablet, a smartphone, a server, a collection of servers, and/or any suitable computing device for sending and receiving signals over the communication network 1708. In at least one example embodiment, the one or more network devices correspond to another datacenter, similar to or the same as datacenter.

As noted above, the datacenter and/or the network device(s) may include storage devices and/or processing circuitry for carrying out computing tasks, for example, tasks associated with controlling the flow of data internally and/or over the communication network. Such processing circuitry may comprise software, hardware, or a combination thereof. For example, the processing circuitry may include a memory including executable instructions and a processor (e.g., a microprocessor) that executes the instructions on the memory. The memory may correspond to any suitable type of memory device or collection of memory devices configured to store instructions. Non-limiting examples of suitable memory devices that may be used include Flash memory, Random Access Memory (RAM), Read Only Memory (ROM), variants thereof, combinations thereof, or the like. In some embodiments, the memory and processor may be integrated into a common device (e.g., a microprocessor may include integrated memory). Additionally or alternatively, the processing circuitry may comprise hardware, such as an application specific integrated circuit (ASIC). Other non-limiting examples of the processing circuitry include an Integrated Circuit (IC) chip, a Central Processing Unit (CPU), a Graphics Processing Unit (GPU), a microprocessor, a Field Programmable Gate Array (FPGA), a collection of logic gates or transistors, resistors, capacitors, inductors, diodes, or the like. Some or all of the processing circuitry may be provided on a Printed Circuit Board (PCB) or collection of PCBs. It should be appreciated that any appropriate type of electrical component or collection of electrical components may be suitable for inclusion in the processing circuitry.

In addition, although not explicitly shown, it should be appreciated that the datacenter and network device(s) may include one or more communication interfaces for facilitating wired and/or wireless communication between one another and other unillustrated elements of the data center environment. These communication interfaces may include a variety of technologies, including but not limited to Ethernet ports, fiber optic connections, Wi-Fi® transceivers, Bluetooth® modules, and cellular communication modules for integration and interoperability among the various components within the data center environment. Furthermore, it should be understood that the data center environment may include additional components and functionalities within the scope of the present disclosure. These components may comprise, without limitation, additional processing units, specialized accelerators (such as Tensor Processing Units or TPUs), enhanced security modules, and redundant power supplies. The inclusion of these elements is intended to ensure that the data center environment is robust, scalable, and capable of meeting diverse operational requirements. Any variations, modifications, or adaptations of the described elements that fall within the spirit and scope of the disclosure are considered to be encompassed by the present disclosure. This includes any combinations, sub-combinations, or enhancements of the various described elements to achieve improved performance, reliability, and efficiency in the data center environment 100.

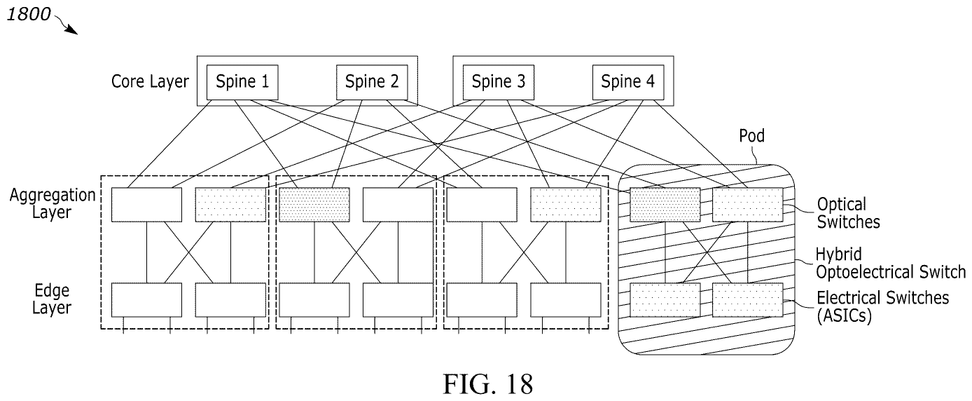

FIG. 18 illustrates a fat tree topology 1800 for a datacenter, in accordance with embodiments of the disclosure. However, it is to be understood that the present disclosure is not limited to a fat tree topology. Other network topologies may also be contemplated within the scope of the disclosure. Examples of such alternative topologies include, but are not limited to, Slim Fly topology, which is designed to reduce the number of hops and cable lengths between nodes; Dragonfly topology, which aims to enhance network scalability and reduce latency through a hierarchical group of interconnected switches; and other hierarchical or non-hierarchical topologies that may be optimized for specific performance, scalability, or cost considerations. The principles and innovations disclosed herein can be applied to these and other network topologies to achieve similar advantages and benefits. Any modifications, variations, or adaptations of the network topologies that fall within the spirit and scope of the present disclosure are considered to be encompassed by this disclosure. In related art systems, a fat tree topology may use the same electrical switching devices on all layers (edge, aggregation, core). For example, each switching device may be 1 U switch, where 1 U refers to the industry standard size for rack-mounted switch and/or server. The interconnection between switches of different layers may be accomplished with optical links using active optical cables and optical transceivers implemented in a pluggable form factor (also referred to as “pluggables”).

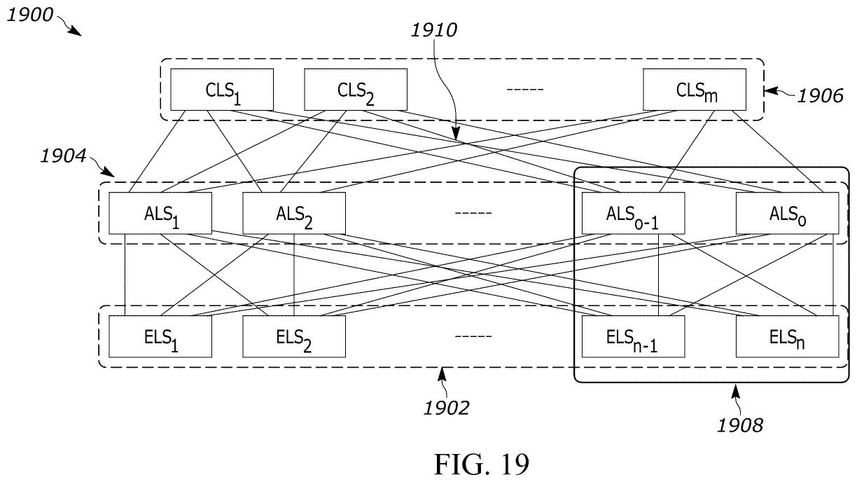

FIG. 19 is an example of a fat tree topology 1900 of a network. As shown in FIG. 19, the fat tree topology may include three distinct layers: the edge layer 1902, the aggregation layer 1904, and the core layer 1906. The edge layer 1902, located at the bottom of the hierarchy, incorporates Top-of-Rack (ToR) switches. The edge layer 1902 may serve as the initial point of aggregation for traffic originating from the servers. The servers and server racks are generally connected to the edge layer 1902, although they are not illustrated in the figure. The edge layer 1902 may include a plurality of switches, designated as ELS1, ELS2, . . . , ELSn, as shown in FIG. 19. The aggregation layer 1904 may be positioned above the edge layer 1902 and may further consolidate traffic from multiple edge layer switches ELS1, ELS2, . . . , ELSn. The aggregation layer 1904 may be composed of switches ALS1, ALS2, . . . , ALSo. The aggregation layer switches may be configured to aggregate data traffic from the edge layer 1902, ensuring efficient load balancing and data flow management. At the top of the hierarchy is the core layer 1906, which may provide high-speed interconnectivity and enables communication among different racks within a datacenter. The core layer 1906 may include a series of switches labeled as CLS1, CLS2, . . . , CLSm. These core layer switches may be configured to ensure that data can traverse the network quickly and efficiently, minimizing latency and maximizing bandwidth.

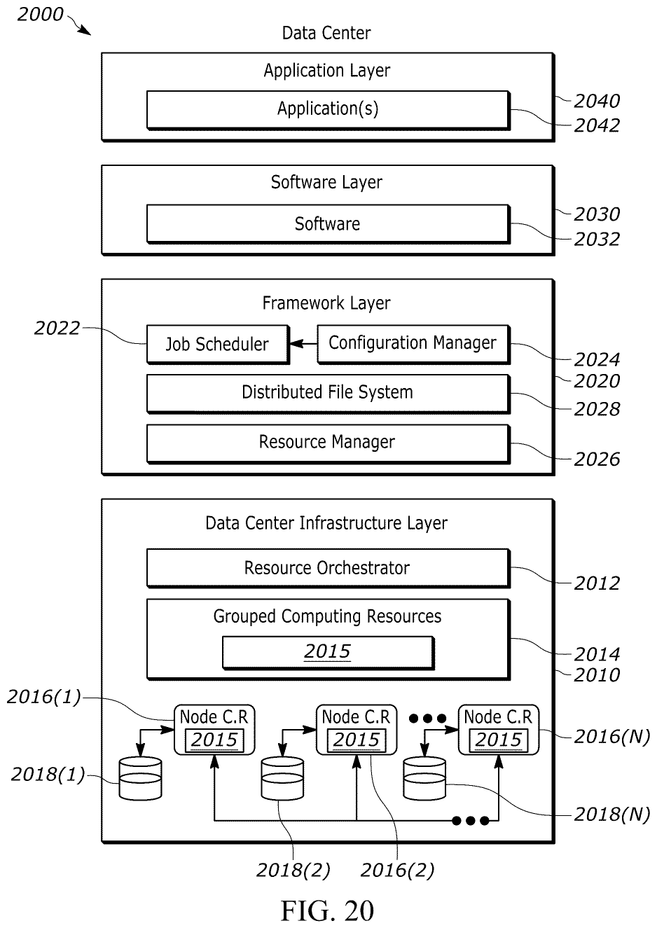

Optical data center networks rely on allocation and deallocation of light paths from the data sources to the destinations end-ports to guarantee no light collisions and data loss occur in the fabric. Traditionally, the allocation algorithms are run from a central entity which considers the entire demand for source and destination flows and try to find the most dense mapping of these demands to network resources over a single or multiple time periods. FIG. 20 illustrates an example data center 2000, in which at least one embodiment may be used. In at least one embodiment, data center 2000 includes a data center infrastructure layer 2010, a framework layer 2020, a software layer 2030 and an application layer 2040.

In at least one embodiment, as shown in FIG. 20, data center infrastructure layer 2010 may include a resource orchestrator 2012, grouped computing resources 2014, and node computing resources (“node C.R.s”) 206(1)-206(N), where “N” represents a positive integer (which may be a different integer “N” than used in other figures). In at least one embodiment, node C.R.s 2016(1)-2016(N) may include, but are not limited to, any number of central processing units (“CPUs”) or other processors (including accelerators, field programmable gate arrays (FPGAs), graphics processors, etc.), memory storage devices 2018(1)-2018(N) (e.g., dynamic read-only memory, solid state storage or disk drives), network input/output (“NW I/O”) devices, network switches, virtual machines (“VMs”), power modules, and cooling modules, etc. In at least one embodiment, one or more node C.R.s from among node C.R.s 2016(1)-2016(N) may be a server having one or more of above-mentioned computing resources.

In at least one embodiment, grouped computing resources 2014 may include separate groupings of node C.R.s housed within one or more racks (not shown), or many racks housed in data centers at various geographical locations (also not shown). In at least one embodiment, separate groupings of node C.R.s within grouped computing resources 2014 may include grouped compute, network, memory or storage resources that may be configured or allocated to support one or more workloads. In at least one embodiment, several node C.R.s including CPUs or processors may be grouped within one or more racks to provide compute resources to support one or more workloads. In at least one embodiment, one or more racks may also include any number of power modules, cooling modules, and network switches, in any combination.

In at least one embodiment, resource orchestrator 2012 may configure or otherwise control one or more node C.R.s 2016(1)-2016(N) and/or grouped computing resources 2014. In at least one embodiment, resource orchestrator 2012 may include a software design infrastructure (“SDI”) management entity for data center 2000. In at least one embodiment, resource orchestrator 2012 may include hardware, software or some combination thereof.

In at least one embodiment, as shown in FIG. 20, framework layer 2020 includes a job scheduler 2022, a configuration manager 2024, a resource manager 2026 and a distributed file system 2028. In at least one embodiment, framework layer 2020 may include a framework to support software 2032 of software layer 2030 and/or one or more application(s) 2042 of application layer 2040. In at least one embodiment, software 2032 or application(s) 2042 may respectively include web-based service software or applications, such as those provided by Amazon Web Services, Google Cloud and Microsoft Azure. In at least one embodiment, framework layer 2020 may be, but is not limited to, a type of free and open-source software web application framework such as Apache Spark™ (hereinafter “Spark”) that may use distributed file system 2028 for large-scale data processing (e.g., “big data”). In at least one embodiment, job scheduler 2022 may include a Spark driver to facilitate scheduling of workloads supported by various layers of data center 2000. In at least one embodiment, configuration manager 2024 may be capable of configuring different layers such as software layer 2030 and framework layer 2020 including Spark and distributed file system 2028 for supporting large-scale data processing. In at least one embodiment, resource manager 2026 may be capable of managing clustered or grouped computing resources mapped to or allocated for support of distributed file system 2028 and job scheduler 2022. In at least one embodiment, clustered or grouped computing resources may include grouped computing resources 2014 at data center infrastructure layer 2010. In at least one embodiment, resource manager 2026 may coordinate with resource orchestrator 2012 to manage these mapped or allocated computing resources.

In at least one embodiment, software 2032 included in software layer 2030 may include software used by at least portions of node C.R.s 2016(1)-2016(N), grouped computing resources 2014, and/or distributed file system 2028 of framework layer 2020. In at least one embodiment, one or more types of software may include, but are not limited to, Internet web page search software, e-mail virus scan software, database software, and streaming video content software.

In at least one embodiment, application(s) 2042 included in application layer 2040 may include one or more types of applications used by at least portions of node C.R.s 2016(1)-2016(N), grouped computing resources 2014, and/or distributed file system 2028 of framework layer 2020. In at least one embodiment, one or more types of applications may include, but are not limited to, any number of a genomics application, a cognitive compute, application and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 2024, resource manager 2026, and resource orchestrator 2012 may implement any number and type of self-modifying actions based on any amount and type of data acquired in any technically feasible fashion. In at least one embodiment, self-modifying actions may relieve a data center operator of data center 2000 from making possibly bad configuration decisions and possibly avoiding underused and/or poor performing portions of a data center.

In at least one embodiment, data center 2000 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 2000. In at least one embodiment, trained machine learning models corresponding to one or more neural networks may be used to infer or predict information using resources described above with respect to data center 2000 by using weight parameters calculated through one or more training techniques described herein.

A photonic neural network (PNN) system may include a number of optical interconnect structures. The optical interconnect structure may be configured to transmit/receive an optical signal (e.g., light), and direct or otherwise guide the optical signal via optical waveguides from/to one or more optical devices (e.g., modulators and photodetectors). In some scenarios, these optical waveguides may be formed in a single level. In consideration of saving a total area occupied by the corresponding photonic die, such optical waveguides may be formed (e.g., stacked) across multiple levels. When being stacked, each of the waveguides typically has a certain portion vertically overlapped with (a portion) of a neighboring waveguide. Each of the waveguides may be formed as having a transitioning portion interposed between two tapered portions to optically communicate with each other and assure the optical signal propagated therein can be saturated.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 2015 are used to perform inferencing and/or training operations associated with one or more embodiments. In at least one embodiment, inference and/or training logic 2015 may be used in system FIG. 20 for inferencing or predicting operations based, at least in part, on weight parameters calculated using neural network training operations, neural network functions and/or architectures, or neural network use cases described herein.

In at least one embodiment, an artificial intelligence (AI) data center infrastructure platform is provided. Examples of an AI data center infrastructure platform are Nvidia® DGX™ SuperPOD™ and DGX™ Foundry. In at least one embodiment, an AI data center infrastructure platform provides accelerated infrastructure and/or scalable performance tailored for AI such as machine learning (ML) and other high-performance computing (HPC) loads.

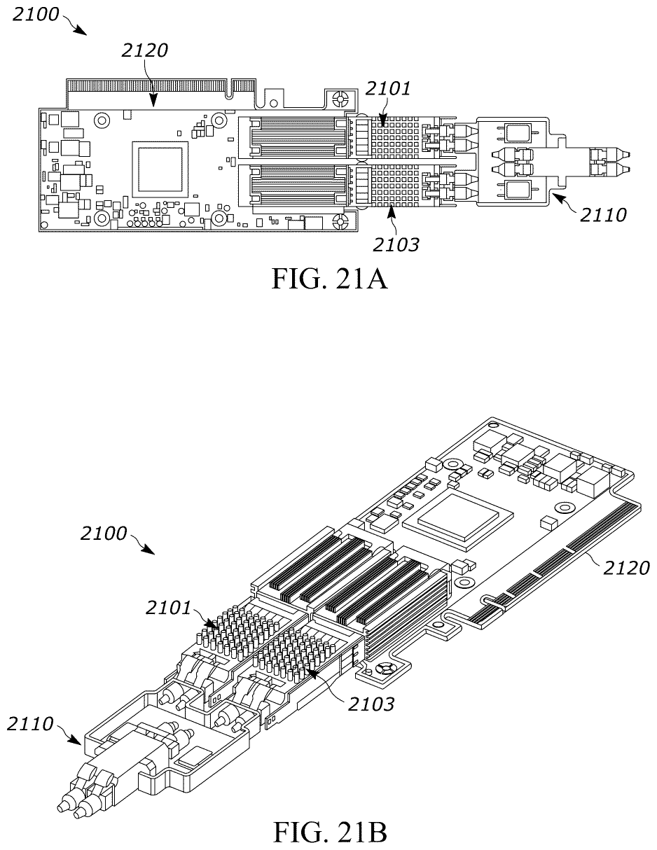

FIGS. 21A and 21B illustrate a top view and a perspective view, respectively, of a transceiver module operatively coupled to a network adapter, in the present example a Network Interface Controller (NIC) 900, in accordance with an embodiment of the disclosure. As shown in FIGS. 21A and 21B, the transceiver module may include a first optical module 2101, a second optical module 2103, an adapter 2110, and a dual-port NIC 2120 of a server. Both the first optical module 2101 and the second optical module 2103 may be dual-fiber transceivers that are configured for duplex communication that allows the source (e.g., server) to communicate with the target (e.g., leaf switch) in both directions. The adapter 2110 may be a ganged physical component configured to link the first optical module 2101 and the second optical module 2103 for the purpose of transmitting and receiving data to and from the leaf switch.

In some embodiments, the adapter 2110 may be configured to operate in two configurations, such as a first configuration and a second configuration. In one aspect, the first configuration may be a default configuration of operation, where the first optical module 2101 may be operationally active. The second configuration may be a contingent configuration that is implemented when the first optical module 2101 operationally fails. When such a failure is detected, the second optical module 2103, which is otherwise operationally inactive or idle, may be engaged become operationally active and handle all network traffic that was initially handled by the first optical module 2101.

In some embodiments, the transceiver module 2100 may be configured to operate in a leaf-spine architecture. A leaf-spine architecture is a data center network topology that may include two switching layers—a spine layer and a leaf layer. The leaf layer may include access switches (leaf switches) that aggregate traffic from servers and connect directly into the spine or network core. Spine switches interconnect all leaf switches in a full-mesh topology between access switches in the leaf layer and the servers from which the access switches aggregate traffic. As such, in one embodiment, to ensure reliable operation of downlinks, the transceiver module 2100 may be configured to operate between the server and the leaf layer. In particular, as shown in FIGS. 21A and 21B, the adapter 2110 may be operatively coupled to the first optical module 2101 and the second optical module 2103, while the first optical module 2101 and the second optical module 2103 may be operatively coupled to a dual-port NIC 2120 of a server.

In embodiments, NIC 2100 may comprise one or more processing circuits, as detailed above; the processing circuits may comprise FW, that is loaded according to the techniques described above.

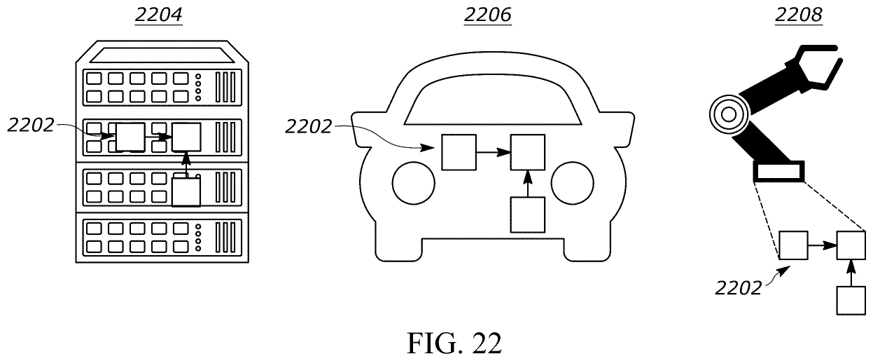

FIG. 22 depicts exemplary scenarios for use of an optical transceiver 2202 in accordance with some embodiments. An optical transceiver 2202 may be utilized in a computing system 2204 (e.g., in a server farm, or within a server computer system), a vehicle 2206 (e.g., a car, truck, train, or airplane), and a robot 2208 (or among robots in a factory), to name just a few examples. The optical transceiver 2202 may be particularly useful for high-speed communication in environments subject to high levels of electromagnetic interference (EMI).

System Overview: The systems and methods described herein may be implemented across a range of data center and high-performance computing environments. In some embodiments, components may include one or more optical transceivers, photonic integrated circuits (PICs), electronic processors, memory units, and programmable logic (e.g., FPGAs or ASICs).

The system architecture may include a layered protocol stack enabling optical interconnects between compute nodes, GPUs, or switch fabrics. Although described in the context of optical signaling (e.g., PAM4 modulation over silicon photonics), the methods may be adapted for use in electrical signaling environments or hybrid opto-electrical systems.

Hardware/Software Flexibility: Aspects of the disclosed technology may be implemented in hardware, software, firmware, or combinations thereof. For example, a congestion-aware routing module may be realized as a hardware IP block, or as software instructions executing on a network controller.

The system may include machine-readable instructions stored in non-transitory memory that, when executed, cause the system to perform steps such as: dynamic wavelength assignment, error correction encoding, channel bonding, or adaptive modulation format selection.

Modularity & Scalability: In some implementations, system components may be distributed across multiple dies or chiplets interconnected via high-speed SerDes lanes, optical waveguides, or interposer-based photonic links. Embodiments may support scaling from single-link configurations to mesh, torus, or custom topologies based on application workload requirements.

Terminology: As used herein, terms like “transmit unit,” “controller,” “interconnect fabric,” or “node” are not limited to any specific implementation, and may encompass hardware, virtualized, or software-defined instances depending on deployment context.

Although specific embodiments of the disclosure have been described and illustrated, the disclosure is not to be limited to the specific forms or arrangements of parts so described and illustrated. The scope of the disclosure is to be defined by the claims appended hereto and their equivalents.

What is claimed is:

1. A pluggable electronic module comprising:
a housing that includes a rigid portion and a low friction portion covering at least a portion of the rigid portion.

2. The pluggable electronic module of claim 1, wherein the low friction portion of the housing enables smooth insertion of the pluggable electronic module into a cage.

3. The pluggable electronic module of claim 1, wherein the rigid portion of the housing is formed of a first material and the low friction portion of the housing is formed of a second material.

4. The pluggable electronic module of claim 1, wherein the rigid portion of the housing is formed of a first material and the low friction portion of the housing is formed of a second material, wherein the second material has a reduced coefficient of friction relative to the first material, which enables smooth insertion of the pluggable electronic module into a cage.

5. The pluggable electronic module of claim 1, wherein the rigid portion of the housing and the low friction portion of the housing are at a leading edge of a back end of the pluggable electronic module.

6. The pluggable electronic module of claim 1, wherein the rigid portion of the housing is part of an integrated heat sink and the low friction portion of the housing is formed over a portion of the integrated heat sink.

7. The pluggable electronic module of claim 1, wherein the rigid portion of the housing is formed of a first material and the low friction portion of the housing is formed of a second material, wherein the first material is metal and the second material is a low friction sticker.

8. The pluggable electronic module of claim 1, wherein the rigid portion of the housing is formed of a first material and the low friction portion of the housing is formed of a second material, wherein the first material is metal and the second material is a low friction sticker that includes ultra-high-molecular-weight (UHMW) polyethylene.

9. The pluggable electronic module of claim 1, wherein the low friction portion of the housing is overmolded over the rigid portion of the housing.

10. The pluggable electronic module of claim 1, wherein the rigid portion of the housing is formed of a first material and the low friction portion of the housing is formed of a second material, wherein the first material is metal and the second material is a molded material.

11. The pluggable electronic module of claim 1, wherein the rigid portion of the housing is formed of a first material and the low friction portion of the housing is formed of a second material, wherein the first material is metal and the second material is a molded nylon.

12. The pluggable electronic module of claim 1, wherein the low friction portion of the housing is coated over the rigid portion of the housing.

13. The pluggable electronic module of claim 1, wherein the rigid portion of the housing is formed of a first material and the low friction portion of the housing is formed of a second material, wherein the first material is metal and the second material is a coating material.

14. The pluggable electronic module of claim 1, wherein the rigid portion is formed of a first material and the low friction portion is formed of a second material, wherein the first material is metal and the second material is a TEFLON based coating.

15. The pluggable electronic module of claim 1, wherein the pluggable electronic module includes a communications circuit within the housing, the communications circuit including a cable connector at a front end of the housing and a PCB interface at a back end of the housing.

16. The pluggable electronic module of claim 1, wherein the pluggable electronic module is an optical transceiver that includes a communications circuit within the housing, the communications circuit including a cable connector at a front end of the housing and a PCB interface at a back end of the housing.

17. The pluggable electronic module of claim 1, wherein the housing of the pluggable electronic module has length, width, and height dimensions, and wherein the low friction portion of the housing spans the width dimension of the housing.

18. A pluggable electronic module comprising:
a housing having a front end and a back end;
a communications media interface at the front end of the housing; and
a rigid portion at the back end and a low friction portion covering at least a portion of the rigid portion.

19. The pluggable electronic module of claim 18, wherein the rigid portion of the housing is formed of a first material and the low friction portion of the housing is formed of a second material.

20. A pluggable electronic module comprising:
an elongated housing having a front end and a back end, wherein;
the front end of the elongated housing includes a communications media interface; and
the back end of the housing includes a rigid portion and a low friction portion covering at least a portion of the rigid portion.
